(19) United States
(12) Patent Application Publication
(10) Pub. No.: US 2025/0062910 A1
(43) Pub. Date: Feb. 20, 2025

(54) DIGITAL PASS OPEN ACCESS PLATFORM

(71) Applicant: Apple Inc., Cupertino, CA (US)

(72) Inventors: Jing JIN, San Jose, CA (US); Trevor W. YOUNG, Livermore, CA (US); Gokul P. THIRUMALAI, Mountain View, CA (US)

(21) Appl. No.: 18/372,688

(22) Filed: Sep. 25, 2023

Related U.S. Application Data
(60) Provisional application No. 63/532,667, filed on Aug. 14, 2023.

(51) Int. Cl. H04L 9/32; H04L 9/30

(52) U.S. Cl. CPC H04L 9/3247; H04L 9/30

(57) ABSTRACT

The subject system may be implemented by a processor circuit configured to receive a digital pass from a first server. The digital pass comprises one or more attributes. The processor circuit is also configured to transmit, to a second server, a request to access a service associated with at least one of the one or more attributes of the digital pass, receive, from the second server, a request for verification of the one or more attributes, transmit, responsive to the request, at least a portion of the digital pass including a digital signature to the second server for verification of the one or more attributes, and access the service via the second server based at least in part on transmitting the at least the portion of the digital pass to the second server.

### CROSS-REFERENCE TO RELATED APPLICATIONS

The present application claims the benefit of U.S. Provisional Patent Application Ser. No. 63/532,667, entitled “DIGITAL PASS OPEN ACCESS PLATFORM,” filed Aug. 14, 2023, which is hereby incorporated herein by reference in its entirety and made part of the present U.S. Utility Patent Application for all purposes.

### TECHNICAL FIELD

The present description generally relates to transactions utilizing electronic devices and, more particularly, to credentials issued by a party for use with the party and/or one or more other parties.

### BACKGROUND

Mobile and electronic wallets offer convenience and security by eliminating the need to carry physical credentials (e.g., payment cards, loyalty cards, membership cards, and the like), thereby reducing the risk of fraud and theft. They are becoming increasingly popular as more merchants accept mobile credentials.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for implementing the subject methods and systems, in accordance with one or more implementations.

FIG. 2 depicts an example electronic device that may implement the subject methods and systems, in accordance with one or more implementations.

FIG. 3A depicts an example application requesting an example digital pass, in accordance with one or more implementations.

FIG. 3D depicts an example system interface for presenting the example digital pass, in accordance with one or more implementations.

FIG. 3C depicts an example application providing a feature exclusive to digital pass holders, in accordance with one or more implementations.

FIG. 4A depicts an example authentication device requesting an example digital pass, in accordance with one or more implementations.

FIG. 4B depicts an example system interface for presenting the example digital pass, in accordance with one or more implementations.

FIG. 4C depicts an example indication of validity of the digital pass, in accordance with one or more implementations.

FIG. 5 depicts a flow diagram of an example process for receiving and utilizing a digital pass, in accordance with one or more implementations.

FIG. 6 depicts a flow diagram of an example process for provisioning a digital pass, in accordance with one or more implementations.

FIG. 7 depicts an example electronic system with which aspects of the present disclosure may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Electronic wallets allow users to store their digital passes securely on their electronic devices. A digital pass may refer to payment information (e.g., gift cards), membership information, customer loyalty card information, digital vouchers, digital tickets, and the like. Electronic wallets allow users to use their digital passes in person, in-app, or online. Electronic wallets may use various security measures to protect a user's digital passes, including tokenization, encryption, and/or biometric authentication. Tokenization involves replacing sensitive data (e.g., credit card numbers) with a unique token that can be used for transactions without revealing the actual sensitive data.

Aspects of the subject technology introduce a service that allows an entity (e.g., a merchant) to issue digital passes (e.g., memberships, tickets, promotions, vouchers, etc.) to users for use with multiple other entities in a privacy preserving manner. Rather than issuing individual passes made exclusively for integration with a particular third party (e.g., separate digital fan passes for a band and a vendor, the band and a venue, or the band and a merchant), the subject technology includes a single digital pass that may be utilized by multiple third party entities, for example, to provide separate benefits associated with each respective entity. Aspects also include preserving user privacy such that the digital pass issuer is not made aware (e.g. does not know where and/or when) of the usage of the digital pass by the user.

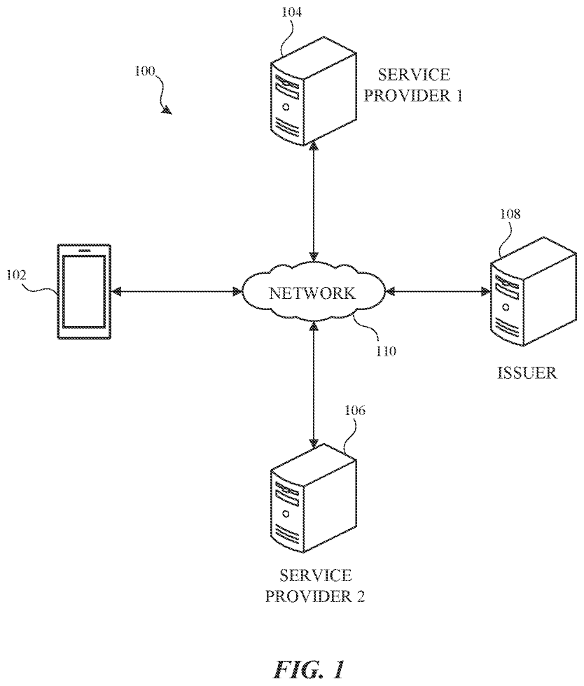

FIG. 1 illustrates an example network environment 100 for implementing the subject methods and systems, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102 and one or more other devices (e.g., a first service provider device 104, a second service provider device 106, and an issuer device 108). The network 110 may communicatively (directly or indirectly) couple the electronic device 102, the first service provider device 104, the second service provider device 106, and/or the issuer device 108. In one or more implementations, the network 110 may be an interconnected network of devices that may include, or may be communicatively coupled to, the internet. For explanatory purposes, the network environment 100 is illustrated in FIG. 1 as including the electronic device 102, the first service provider device 104, the second service provider device 106, and/or the issuer device 108; however, the network environment 100 may include any number of electronic devices and/or any number of servers communicatively coupled to each other directly or via the network 110.

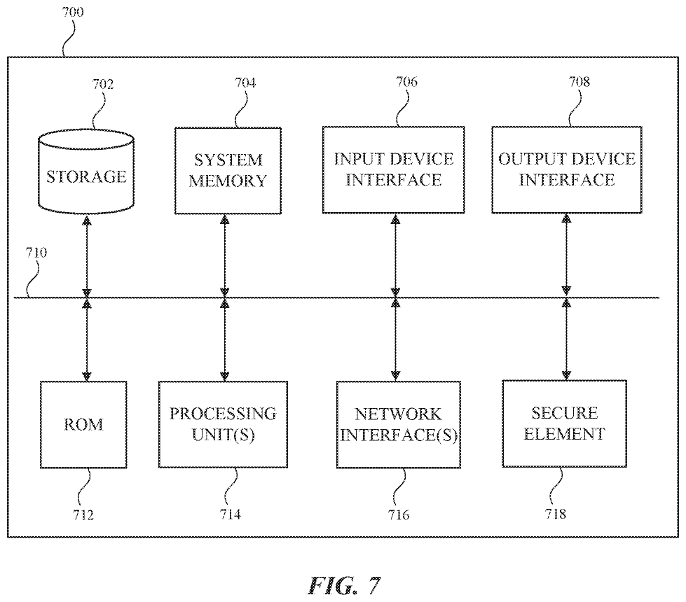

The electronic device 102 may be, for example, a wearable device (e.g., a watch, a band, and the like), a desktop computer, a portable computing device (e.g., a laptop computer, smartphone, tablet, and the like), a peripheral device (e.g., a digital camera, headphones, and the like), or any other appropriate device that includes, for example, one or more wireless interfaces, such as WL AN radios, cellular radios, Bluetooth radios, Zigbee radios, near field communication (NFC) radios, and/or other wireless radios. In FIG. 1, by way of example, the electronic device 102 is depicted as a smartphone. The electronic device 102 may be, and/or may include all or part of, the electronic system discussed below with respect to FIG. 7 and may be associated with a user account. For example, the electronic device 102 may be registered to one or more user accounts associated with the first service provider device 104, the second service provider device 106, and the issuer device 108.

The issuer device 108 may also be, for example, a server, a wearable device (e.g., a watch, a band, and the like), a desktop computer, a portable computing device (e.g., a laptop computer, smartphone, tablet, and the like), a peripheral device (e.g., a digital camera, headphones, and the like), or any other appropriate device that includes, for example, one or more wireless interfaces, such as WLAN radios, cellular radios, Bluetooth radios, Zigbee radios, NFC radios, and/or other wireless radios. In FIG. 1, by way of example, the issuer device 108 is depicted as a server.

The issuer device 108 may be configured to provision digital pass(es) onto electronic devices (e.g., the electronic device 102). Digital passes may include one or more identifiers in the form of a code, signal (e.g., an NFC signal), token, cryptogram, and the like. In some variations, the issuer device 108 may include one or more app-specific modules (e.g., plugins) (and/or separate servers) that perform operations for a respective application (e.g., provisioning and verifying digital passes). In one or more implementations, a digital pass may be provisioned as an applet on a secure element of the electronic device 102, such as by the issuer device 108, and/or a digital pass may be stored in memory and managed/accessed by a host or application processor of the electronic device 102. The issuer device 108 may be configured to store one or more public keys corresponding to one or more private keys generated (e.g., by the electronic device 102) at the direction and/or in association with the issuer device 108.

The issuer device 108 may store account information (e.g., user account, usernames/handles, or any other account-specific data) associated with the electronic device 102 and/or users thereof and/or users associated therewith. In one or more implementations, one or more servers (e.g., the issuer device 108) may provide digital passes that are to be provisioned (e.g., stored) on or at a device (e.g., the electronic device 102) by an application, operating system, and/or secure element of the device. In one or more implementations, the electronic device 102 may be communicatively coupled to service provider device(s) (e.g., the first service provider device 104 and/or the second service provider device 106) to provide a digital pass to the service provider device(s).

The service provider device(s) (e.g., the first service provider device 104 and the second service provider device 106) may be configured to receive and/or verify digital passes. A service provider device may be, for example, a server, a wearable device (e.g., a watch, a band, and the like), a desktop computer, a portable computing device (e.g., a laptop computer, smartphone, tablet, and the like), a peripheral device (e.g., a digital camera, headphones, and the like), or any other appropriate device that includes, for example, one or more wireless interfaces, such as WLAN radios, cellular radios, Bluetooth radios, Zigbee radios, NFC radios, and/or other wireless radios. In FIG. 1, by way of example, the first service provider device 104 and the second service provider device 106 are depicted as servers. The service provider device(s) may be configured to provide an indication that the digital pass is valid. For example, a service provider device may include a display that presents a green checkmark when the service provider device successfully validates a physically presented digital pass (e.g., via an NFC terminal). As another example, a service provider device may transmit a signal that indicates a successful validation when the service provider device successfully validates a virtually presented digital pass (e.g., via a web browser and/or over a network). The service provider device(s) may be configured to access, request, download, or otherwise obtain one or more keys (e.g., public key associated with a digital pass) from the issuer device 108 (e.g., to validate a chain of trust during a one-time setup between the service provider device(s) and the electronic device 102).

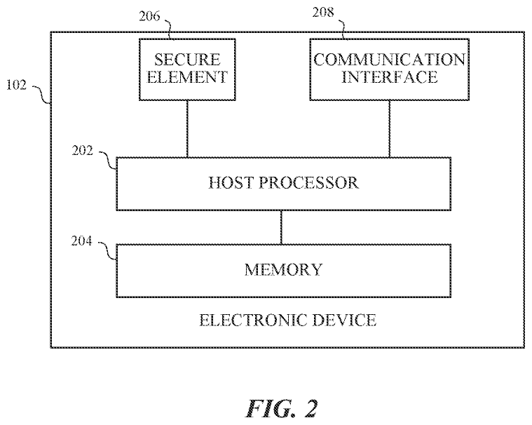

FIG. 2 depicts an example electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, a secure element 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store user location data, track data (e.g., lane information), exercise data (e.g., biometrics), account data, and any other data generated in the course of performing the processes described herein.

The secure element 206 may include hardware that provides secure storage and management of sensitive information. The secure element 206 may be securely isolated from the host processor 202 and/or operating system, making it more difficult for unauthorized access. The secure element 206 may be used for secure transactions and identification, such as in digital passes, payment credentials, and the like. The secure element 206 may store sensitive information, such as cryptographic keys, and may protect the sensitive information with cryptographic algorithms and access controls. For example, the secure element 206 may include a hardware specific private key that is provisioned on the secure element 206 at or near the time of manufacture. The use of the secure element 206 provides an additional layer of security for sensitive information and helps to ensure its confidentiality in case the electronic device 102 is lost or compromised.

The communication interface 208 may include suitable logic, circuitry, and/or code that enables wired or wireless communication, such as between the electronic device 102 and a service provider device. The communication interface 208 may include, for example, one or more of a Bluetooth communication interface, an NFC interface, a Zigbee communication interface, a WLAN communication interface, a USB communication interface, a cellular interface, or generally any communication interface.

In one or more implementations, one or more of the host processor 202, the memory 204, the secure element 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

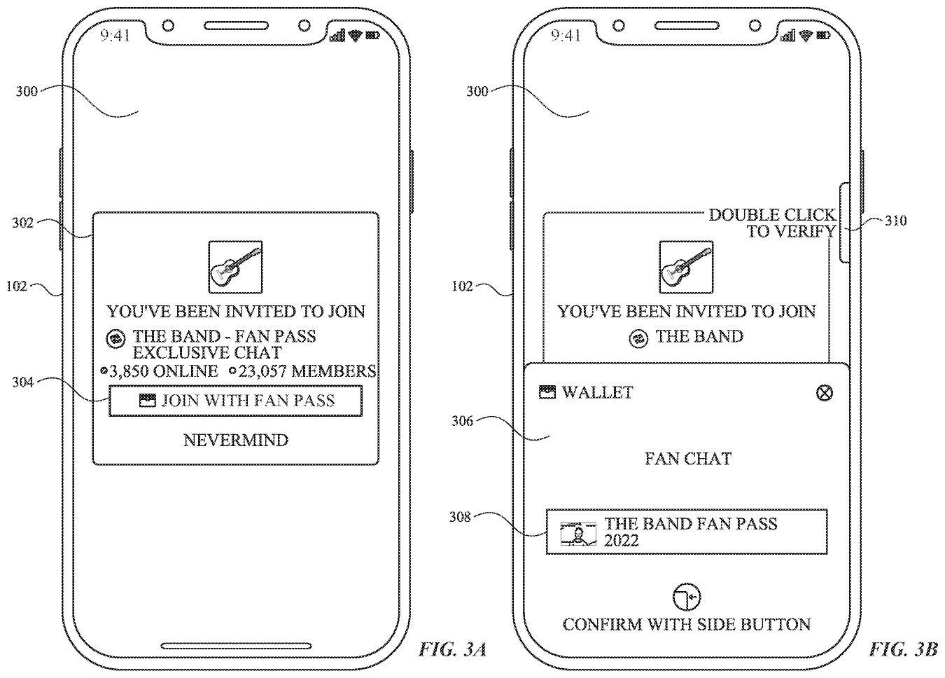

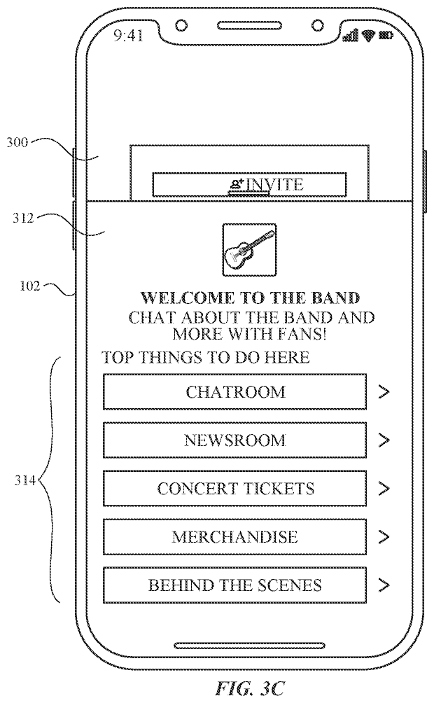

Digital passes issued as part of the subject technology may be provided in, for instance, a digital environment, such as via an application installed on the electronic device 102. In the example described with respect to FIGS. 3A-3C, an entity, such as a band, may sell fan passes that provide fans (e.g., fan pass purchasers) with exclusive benefits at one or more third parties. For example, exclusive benefits may include early access to digital content relating to the band at a digital content platform and/or merchandise relating to the band at a retailer. The fan passes may be sold by the issuer and issued to the electronic device 102 of the user. The user may present the fan pass to a third party electronically via an application 300.

FIG. 3A depicts the application 300 requesting a digital pass, in accordance with one or more implementations. Not all of the depicted components may be used in all implementations, however, and one or more implementations may include additional or different components than those shown in FIGS. 3A-3C. Variations in the arrangement and type of the components may be made without departing from the spirit or scope of the claims as set forth herein. Additional components, different components, or fewer components may be provided.

A third party may be associated with the application 300. The application 300 may run on the electronic device 102, and the backend of the application 300 may be on the first service provider device 104. The application 300 may display a user interface element corresponding to a digital fan club 302 of a band. The digital fan club 302 may be restricted to users who have been issued a digital pass (e.g., a fan pass) by the band. To verify that the user is a member of the digital fan club (e.g., has a digital pass issued by the issuer device 108), the application 300 may provide an option 304 for the user to provide their digital pass in the application 300.

FIG. 3B depicts an example system interface 306 for presenting the example digital pass 308, in accordance with one or more implementations. When a user selects the option 304, the electronic device 102 may ask the user, via the system interface 306, whether the electronic device 102 should provide the digital pass 308 to the application 300.

When the user confirms that the electronic device 102 may present the digital pass 308 to the application 300 via a confirmation interaction 310 (e.g., by double clicking a button on the electronic device 102 and/or via an authentication), the electronic device 102 may perform an in-app presentation of the digital pass 308, which may include sending at least part of the digital pass 308 including a digital signature based on a private key stored on the electronic device 102 (e.g., generated during provisioning of the digital pass 308).

Because the digital pass 308 may be accepted by multiple third parties, the digital pass 308 may include a variety of information that may be relevant in particular contexts and/or to particular third parties. To prevent third parties from receiving more information than necessary and to preserve the privacy of the user, the in-app presentation of the digital pass 308 may only provide information relevant to the current context (e.g., as selected by the user and/or as requested by the application 300). The application 300 may verify (e.g., locally and/or remotely) the information that it received from the electronic device 102.

For example, when the user presses the option 304 to join the digital fan club 302, the application 300 may request, and the electronic device 102 may send, a digital signature that was included with the digital pass 308 when it was issued by the issuer device 108. The application 300 may verify the digital signature (e.g., with a public key associated with the digital pass and obtained from the issuer server 108) and allow the electronic device 102 to enter the digital fan club 302, if the digital signature is successfully verified.

FIG. 3C depicts the example application 300 providing a feature exclusive to holders of the digital pass 308, in accordance with one or more implementations. If the information from the digital pass 308 (e.g., a digital signature, name, membership date, membership tier, etc.) provided to application 300 is successfully verified, the application 300 may provide an interface 312 including one or more privileges, benefits, information, or other features 314 to the electronic device 102. For example, the features 314 may include activities/services (e.g., a chatroom or newsroom), goods (e.g., concert tickets or merchandise), media (e.g., behind the scenes content), and/or the like accessible only to verified holders of the digital pass 308.

In some implementations, the features 314 may be accessible to anyone but may be modified for holders of the digital pass 308. For example, a digital storefront may include merchandise available for purchase by anyone but may be modified to include reduced pricing for holders of the digital pass 308.

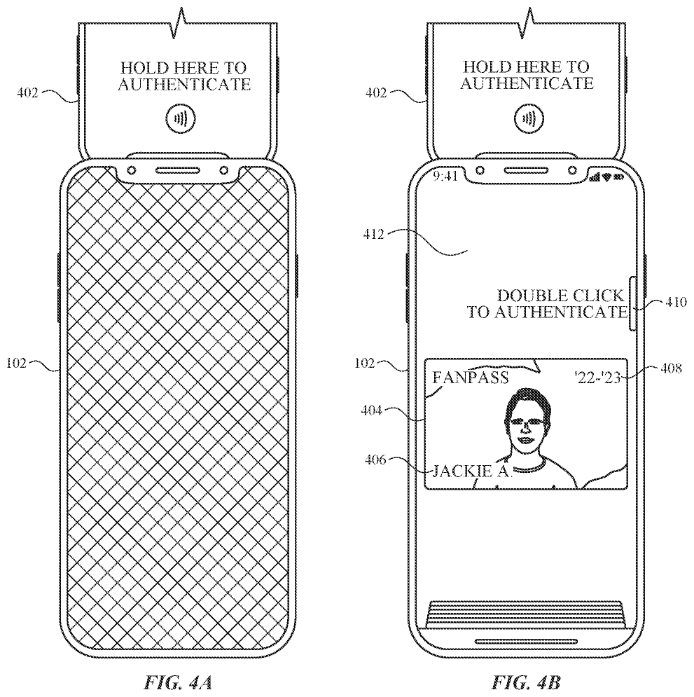

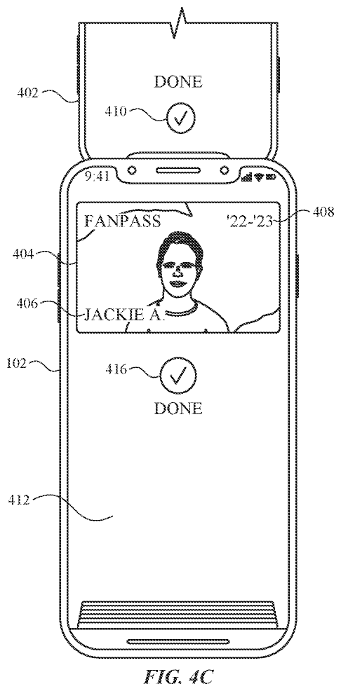

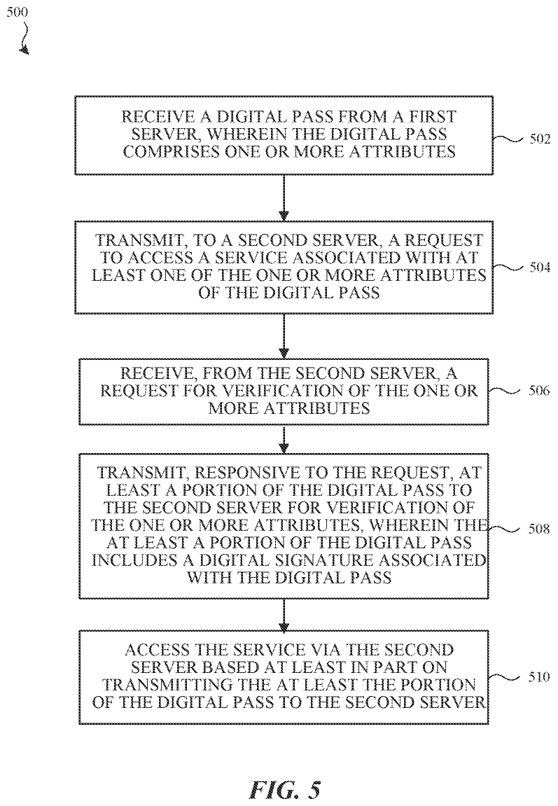

Digital passes issued as part of the subject technology may be provided in, for instance, a physical environment, such as via a mobile authentication device 402 nearby the electronic device 102. In the example described with respect to FIGS. 4A-4C, a band may sell fan passes that provide fans (e.g., fan pass purchasers) with exclusive benefits at one or more third parties. For example, exclusive benefits may include access to physical locations (e.g., stage or backstage tours) and/or merchandise relating to the band at a retailer. The fan passes may be sold by the issuer and issued to the electronic device 102 of the user. The user may present the fan pass to a third party physically (e.g., by displaying on the electronic device 102 a barcode, QR code, and the like) and/or electronically (e.g., by NFC transmission to the authentication device 402).

FIG. 4A depicts an example authentication device 402 requesting an example digital pass, in accordance with one or more implementations. Not all of the depicted components may be used in all implementations, however, and one or more implementations may include additional or different components than those shown in FIGS. 4A-4C. Variations in the arrangement and type of the components may be made without departing from the spirit or scope of the claims as set forth herein. Additional components, different components, or fewer components may be provided.

For example, a user of the electronic device 102 may approach an entrance to a physical location that has limited access to purchasers of a particular digital pass (e.g., a fan pass). The entrance may include an authentication device 402 for the user to prove that they have purchased the relevant pass. The authentication device 402 may request that the user present the digital pass, for example, via NFC. The authentication device 402 may be a terminal, smartphone, computer, or any other kind of electronic device configured to send and receive data such as data included in a digital pass.

FIG. 4B depicts an example system interface 412 for presenting the example digital pass 404, in accordance with one or more implementations. The system interface 412 may be rendered as a digital wallet, and the digital pass 404 may be rendered as a card. When the user brings the electronic device 102 near the authentication device 402, the electronic device 102 may ask the user, via the system interface 412, whether the electronic device 102 should provide the digital pass 404 to the authentication device 402.

When the user confirms that the electronic device 102 may present the digital pass 404 to the authentication device 402 via a confirmation interaction 410 (e.g., by double clicking a button on the electronic device 102), the electronic device 102 may perform a presentation of the digital pass 404, which may include sending at least part of the digital pass 404 to the authentication device 402 and/or displaying the digital pass 404, which includes a digital signature based on a private key stored on the electronic device 102 (e.g., generated during provisioning of the digital pass 308).

In one or more implementations, the digital pass 404 may be valid at multiple third parties. For example, the digital pass 404 that is valid at a physical location may be the same as the digital pass 308 that is valid at an online location. Because the digital pass 404 is valid at multiple third parties (e.g., in-app and in person), the digital pass 404 may include a variety of information that may be relevant in particular contexts and/or to particular third parties. To prevent third parties from receiving more information than necessary and to preserve the privacy of the user, the presentation of the digital pass 404 may only provide information relevant to the situation at hand (e.g., as selected by the user and/or as requested by the authentication device 402). The authentication device 402 may verify (e.g., locally and/or remotely) the information that it received from the electronic device 102.

For example, when the user brings the electronic device 102 to the authentication device 402, the authentication device 402 may request, and the electronic device 102 may send, a name 406 and pass year 408 of the digital pass 404. The authentication device 402 may verify that the name 406 is included in a list of authorized names corresponding to the pass year 408 (e.g., stored locally on the authentication device 402). Additionally or alternatively, the authentication device 402 may request, and the electronic device 102 may send, a digital signature associated with the digital pass. The authentication device 402 may verify the digital signature (e.g., with a public key associated with the digital pass and obtained from the issuer server 108) and provide an indication (e.g., audio or visual cue) of validity if the digital signature is successfully verified.

FIG. 4C depicts an example indication of the validity of the digital pass 404, in accordance with one or more implementations. If the information from the digital pass 404 (e.g. the name 406, pass year 408, digital signature, etc.) provided to the authentication device 402 is successfully verified, the authentication device 402 may provide an indication of the validity of the digital pass 404. For example, the authentication device 402 may present an icon 414 (e.g., a checkmark) indicating on the authentication device 402 that the digital pass 404 is valid. The indication may also or instead include a signal to the electronic device 102 causing the electronic device 102 to present an icon 416 (e.g., a checkmark) to the user.

FIG. 5 depicts a flow diagram of an example process 500 for receiving and utilizing a digital pass, in accordance with one or more implementations. For explanatory purposes, the process 500 is primarily described herein with reference to the electronic device 102, the first service provider device 104, the second service provider device 106, and the issuer device 108 of FIG. 1. However, the process 500 is not limited to such devices, and one or more blocks of the process 500 may be performed by one or more other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations.

At block 502, a user device (e.g., the electronic device 102) receives a digital pass (e.g., a digital pass 308) from an issuer server (e.g., the issuer device 108). The digital pass may be an electronic document that validates the user's entitlement to particular goods and/or services, such as access to a venue, membership benefits, or the ability to redeem a voucher. The digital pass may include various attributes, which can be any form of data related to the pass. Examples of attributes can include the user's name, the pass's issue and expiry dates, a unique pass identifier, the entity issuing the pass, and any specific benefits or privileges associated with the pass.

Once the digital pass is generated and digitally signed, the issuer server may send it (e.g., over the internet) to the user device, which may be done via various methods, such as email, SMS, or directly through an application interface. The user device may receive the digital pass and store it in the electronic wallet application (e.g., by provisioning the digital pass in a secure element 206 of the user device). The user can then access the digital pass from their device at any time and use it with the various entities that recognize the pass.

In one or more implementations, the issuer device 108 may provision (e.g., over a network or directly via NFC and/or another local peer-to-peer connection) the digital pass on the user device, such as on a secure element of the user device and/or via a host or application processor of the user device.

After receiving the digital pass, the user device may generate a public/private keypair associated with the digital pass, which may be used for generating a digital signature for the digital pass. This digital signature is a cryptographic measure that validates the authenticity of the information contained digital pass. The user device may create the digital signature using its private key, a piece of data that is kept secret by the user device. The user device may provide the public key to the issuer device or some other centralized store of public keys associated with digital passes. When the digital pass is received by a service provider (e.g., first service provider device 104), the service provider may obtain the public key (e.g., from the service provider or some other centralized store of public keys) to verify the digital signature.

In some implementations, the digital pass may be synchronized to other devices belonging to the user. For example, the user device may provide the digital pass to one or more other electronic devices (e.g., via a cloud service) registered to the same user account as the user device.

In some implementations, the user device may receive updates to the digital pass from the issuer server. This could be due to various reasons such as updates to user status, changes in benefits, or to correct errors. When such a change is needed, the issuer server may send a message to the user device indicating a modification to one or more attributes of the digital pass. This message may include details about the modifications, such as which attributes need to be changed and what the new values should be. Upon receiving this message, the user device may retrieve the digital pass from its secure storage and make the corresponding modifications to the attributes.

In one or more implementations, when the digital pass is provisioned on the secure element of the user device, the issuer device may transmit a script to the secure element of the user device that, when executed, updates the digital pass on the secure element.

At block 504, the user device may transmit to a service provider (e.g., first service provider device 104) a request to access a service, such as over a network and/or via a local peer-to-peer connection. A service provider may be a third party entity (e.g., a store, event venue, or an online service) that recognizes the digital pass and provides services or benefits linked to it. The service provider may use a server infrastructure to manage these services, including the verification of digital passes. The services could range from access to a physical location (e.g., a specific venue), discounted goods (e.g., redemption of a voucher), or availing of certain membership benefits. The service provider may have systems in place to authenticate and/or validate digital passes (e.g., via an API provided by the issuer server) and provide the associated service to the user.

The user device may transmit the request when the user decides to access a service associated with the digital pass. This could be done through various methods, such as launching an application (e.g., the application 300) on the user device or using the user device to interact with a physical access control system (e.g., the authentication device 402). The user device may then generate a request to access the service.

At block 506, the user device may receive, from the service provider, a request for verification of one or more attributes of the digital pass to confirm the authenticity of the digital pass and/or the legitimacy of the user's request.

At block 508, in response to the request, the user device may transmit at least a portion of the digital pass to the service provider for verification. Upon receiving this verification request, the user device may retrieve at least a portion of the digital pass (e.g., from the secure element). The part of the digital pass transmitted may depend on the specifics of the request and can include some or all of the digital pass attributes, or even the entire digital pass itself.

In some implementations, the portions of the digital pass transmitted are selected by the user. For example, to preserve the privacy of the user by providing only the information necessary to the service provider, the user may select one or more attributes of the digital pass, such as the name associated with the pass and the year of the pass.

In some implementations, user confirmation might be required before the device transmits any portion of the digital pass, as a measure to ensure user consent and security. To receive user confirmation, some implementations may present an authentication prompt and receive an authentication input (e.g., password, biometric information, and/or the like) in response to the authentication prompt. The user device may determine whether the authentication input is valid based on local authentication data (e.g., a pre-registered password, biometric information, and/or the like). If the authentication input is valid, then the user device may transmit information from the digital pass.

The user device may send the information of the digital pass back to the service provider's server over a secure communication channel. Protocols such as Transport Layer Security (TLS) or Secure Sockets Layer (SSL) can be used to encrypt the data during transmission, ensuring its security and confidentiality.

Once the service provider server receives the portion of the digital pass, it may process the information to verify its authenticity and/or integrity. This could involve checking the digital signature using the public key associated with the digital pass obtained from the issuer server, comparing the digital pass attributes against expected values, or performing other forms of data validation.

At block 510, the user device may access the service (e.g., via the service provider server) based at least in part on transmitting the at least the portion of the digital pass to the service provider. If the service provider successfully verifies the information of the digital pass and determines that the user is authorized to access the requested service, it may then grant access to the service. This could mean, for example, activating certain benefits, allowing the user to redeem a voucher, granting access to a venue or event, or providing any other service associated with the digital pass. If the verification fails, the service provider may deny the service and optionally alert the user or the issuer about the failed verification attempt.

After the initial service access, the user may wish to access a different service from another service provider (e.g., the second service provider device 106) or even the same service provider (e.g., the first service provider device 104) but at a different location (e.g., digital or physical) or different point in time. The user may repeat the process (e.g., blocks 504-510) described above, using the same digital pass. Depending on the verification requirements of the different services and/or different service providers, the user device may transmit the same or different portions of the digital pass.

This reuse of the digital pass in different contexts, such as with different service providers, at different times, and/or for different services, underscores the versatility and convenience of the digital pass provided by the subject system. The digital pass allows users to access multiple services with different service providers using a single digital pass, simplifying the user experience while maintaining robust security standards. The process also benefits service providers, who gain assurance of the authenticity and integrity of digital passes while offering their services to users in a single integration (e.g., with the issuer server).

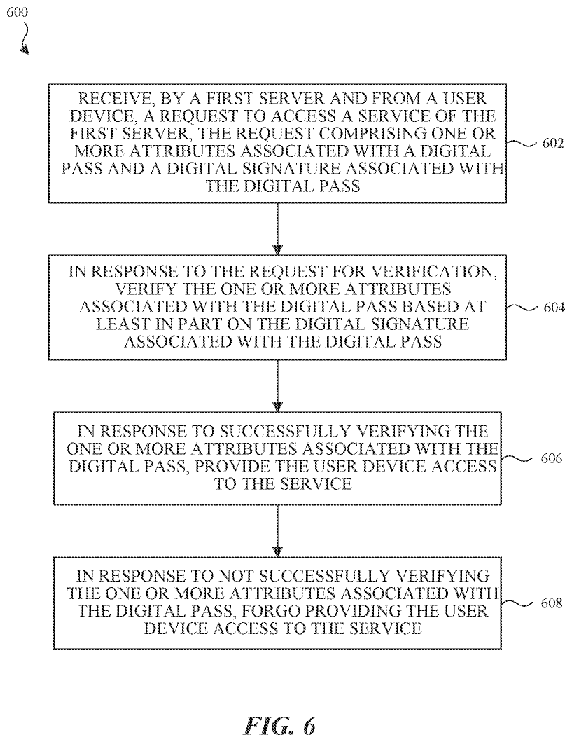

FIG. 6 depicts a flow diagram of an example process 600 for provisioning a digital pass, in accordance with one or more implementations. For explanatory purposes, the process 600 is primarily described herein with reference to the electronic device 102, the first service provider device 104, the second service provider device 106, and the issuer device 108 of FIG. 1. However, the process 600 is not limited such devices, and one or more blocks of the process 600 may be performed by one or more other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, a service provider (e.g., the first service provider device 104) may receive from a user device (e.g., the electronic device 102) a request to access a service of the service provider. The request may include one or more attributes associated with a digital pass (e.g., the digital pass 308) and a digital signature associated with the digital pass.

A service provider server may include digital infrastructure that is managed by a service provider, which can be a retailer, an event organizer, an online service, or any other entity that offers services or benefits associated with a digital pass. The service provider server may handle service management tasks, including the processing of user requests and the verification of digital passes.

The user device, which could be an internet-enabled device like a smartphone, tablet, or smartwatch, securely stores a digital pass (e.g., within a secure element 206). The digital pass may be provided (e.g., provisioned) by the issuer server (e.g., issuer device 108) to the user device, as described above with respect to block 502 of FIG. 5. The digital pass may include various attributes and a digital signature, such as a digital signature provided by the issuer and/or service provider. The attributes may hold the details related to the pass such as the issuer's information, the user's information, benefit information, and other relevant details. The digital signature provides a method to verify the authenticity and integrity of the digital pass.

When a user wishes to access a service offered by the service provider, the user device may communicate with the service provider server. The user device may send (e.g., over a network or via a direct peer-to-peer connection) a request to the service provider server to access the service. The request can include one or more attributes associated with the digital pass, as well as the digital signature.

The included attributes can vary depending on the requirements of the service provider and/or the nature of the service being accessed. The digital signature, generated by the issuer server during the issuance of the digital pass, may allow the service provider server to verify the authenticity of the digital pass.

In some implementations, the request to access the service may be triggered in response to a prior request by the service provider to the user device. The prior request may ask the user device for one or more attributes associated with the digital pass. The user device, upon receiving this request, may retrieve the requested attributes from the digital pass and send them along with the digital signature to the service provider server.

At block 604, in response to the request for verification, the service provider server may verify the one or more attributes associated with the digital pass based at least in part on the digital signature associated with the digital pass.

The verification of the digital pass may include verifying the digital signature. The digital signature may have been originally generated by the user device after the digital pass was issued. The digital signature is a unique cryptographic mark that validates the authenticity and integrity of the digital pass. The digital signature may be verified by using the public key associated with the digital pass (e.g., obtained from the issuer server), which can decode the signature and ascertain whether or not the digital pass has been tampered with. If the digital signature is valid, then the one or more attributes associated with the digital pass may also be considered valid.

In addition to verifying the digital signature, the service provider server may extract and/or examine one or more of the attributes associated with the digital pass. These attributes may represent various details pertaining to the user (e.g., a name, birthday, location, and the like), the issuer (e.g., a name, location, associated service providers, and the like), the service (e.g., a name, location, service provider, associated issuer, and the like), and/or the digital pass itself (e.g., an issue date, expiration date, tier, number of uses, and the like). For example, the service provider may examine one or more attributes of the digital pass to confirm that the digital pass has not expired and/or to confirm that the user has the appropriate tier of pass to access a service provided by the service provider, where a particular tier of pass may correspond to particular services available to the user.

At block 606, if the received attributes are successfully verified, the service provider server may grant the user access to the service.

In some implementations, the service provider may generate an indication of verification, which may be a visual, textual, or auditory cue that confirms that the digital pass has been successfully verified and that access to the service has been granted. This indication of verification may be sent to the user device (e.g., as a data object), where it may be presented on an electronic display. Depending on the design of the service provider's system and the user device, this display might be, for example, the device's main screen, a notification area, a dedicated app interface, or even a wearable device connected to the main device (e.g., a smartwatch). This indication could take various forms such as, for example, a checkmark, a green light, a message (e.g., saying “Verification Successful”), and/or an audio cue. The indication may also or instead include, for example, information about the accessed service, such as details of the benefits granted, instructions for using the service, or other relevant data.

In some implementations, following the user's request to access a service and successful verification of the digital pass, the service provider server may cause at least one attribute associated with the digital pass to be modified. After modifying the attribute on the service provider's side, the service provider server may then transmit an indication of this modification to the issuer server, which may include details about the attribute that was changed and the new value of that attribute. Once the issuer server receives the indication of the modifications, the issuer server may update the digital pass to reflect the modifications made by the service provider, ensuring the user and issuer server have a consistent view of the digital pass status, and send to the user device an updated digital pass.

For example, if a digital pass allows for ten uses and the user has just redeemed one use, the service provider server may decrement the number of remaining uses from ten to nine. The service provider server may then send a message to the issuer server indicating that the “remaining uses” attribute should be updated to nine. The issuer server may then update this attribute in an updated copy of the digital pass and provide the updated digital pass to the user device to replace the digital pass currently on the user device so that both the issuer server and the user see the same number of remaining uses.

At block 608, if the verification process fails at any point—such as when the attributes do not meet the expected values or the digital signature is invalid—the service provider may deny the request for service access and may also notify the user and/or the issuer server about the failed verification attempt.

FIG. 7 depicts an example electronic system 700 with which aspects of the present disclosure may be implemented, in accordance with one or more implementations. The electronic system 700 can be, and/or can be a part of, any electronic device for generating the features and processes described in reference to FIGS. 1-6, including but not limited to a laptop computer, tablet computer, smartphone, and wearable device (e.g., smartwatch, fitness band). The electronic system 700 may include various types of computer-readable media and interfaces for various other types of computer-readable media. The electronic system 700 includes a persistent storage device 702, a system memory 704 (and/or buffer), an input device interface 706, an output device interface 708, a bus 710, a ROM 712, one or more processing unit(s) 714, one or more network interface(s) 716, a secure element 718, and/or subsets and variations thereof.

The bus 710 collectively represents all system, peripheral, and chipset buses that communicatively connect the numerous internal devices of the electronic system 700. In one or more implementations, the bus 710 communicatively connects the one or more processing unit(s) 714 with the ROM 712, the system memory 704, and the persistent storage device 702. From these various memory units, the one or more processing unit(s) 714 retrieves instructions to execute and data to process in order to execute the processes of the subject disclosure. The one or more processing unit(s) 714 can be a single processor or a multi-core processor in different implementations.

The ROM 712 stores static data and instructions that are needed by the one or more processing unit(s) 714 and other modules of the electronic system 700. The persistent storage device 702, on the other hand, may be a read-and-write memory device. The persistent storage device 702 may be a non-volatile memory unit that stores instructions and data even when the electronic system 700 is off. In one or more implementations, a mass-storage device (such as a magnetic or optical disk and its corresponding disk drive) may be used as the persistent storage device 702.

In one or more implementations, a removable storage device (such as a floppy disk, flash drive, and its corresponding disk drive) may be used as the persistent storage device 702. Like the persistent storage device 702, the system memory 704 may be a read-and-write memory device. However, unlike the persistent storage device 702, the system memory 704 may be a volatile read-and-write memory, such as RAM. The system memory 704 may store any of the instructions and data that one or more processing unit(s) 714 may need at runtime. In one or more implementations, the processes of the subject disclosure are stored in the system memory 704, the persistent storage device 702, and/or the ROM 712. From these various memory units, the one or more processing unit(s) 714 retrieves instructions to execute and data to process in order to execute the processes of one or more implementations.

The bus 710 also connects to the input device interfaces 706 and output device interfaces 708. The input device interface 706 enables a user to communicate information and select commands to the electronic system 700. Input devices that may be used with the input device interface 706 may include, for example, alphanumeric keyboards, touch screens, and pointing devices. The output device interface 708 may enable the electronic system 700 to communicate information to users. For example, the output device interface 708 may provide the display of images generated by electronic system 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 710 also connects to secure element 718. The secure element 718 may include hardware and/or software that provides secure storage and management of sensitive information. The secure element 718 may be isolated from the processing unit 714 and operating system, making it more difficult for unauthorized access. The secure element 718 may be used for secure transactions and identification, such as in payment cards/credentials and digital passes. The secure element 718 may store sensitive information, such as cryptographic keys, and may protect the sensitive information (e.g., with cryptographic algorithms and access controls).

Finally, as shown in FIG. 7, the bus 710 also couples the electronic system 700 to one or more networks and/or to one or more network nodes through the one or more network interface(s) 716. In this manner, the electronic system 700 can be a part of a network of computers (such as a local area network, a wide area network, an intranet, or a network of networks, such as the internet). Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more,” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A method comprising:
receiving a digital pass from a first server, wherein the digital pass comprises one or more attributes;
transmitting, to a second server, a request to access a service associated with at least one of the one or more attributes of the digital pass;
receiving, from the second server, a request for verification of the one or more attributes;
transmitting, responsive to the request, at least a portion of the digital pass to the second server for verification of the one or more attributes, wherein the at least a portion of the digital pass includes a digital signature associated with the digital pass; and
accessing the service via the second server based at least in part on transmitting the at least the portion of the digital pass to the second server.

2. The method of claim 1, further comprising:
transmitting, to a third server, a request to access another service associated with at least one of the one or more attributes;
receiving, from the third server, a request for verification of the one or more attributes;
transmitting, responsive to the request, at least a portion of the digital pass to the third server for verification of the one or more attributes, wherein the at least a portion of the digital pass includes the digital signature associated with the digital pass; and
accessing the other service via the third server based at least in part on transmitting the at least the portion of the digital pass to the third server.

3. The method of claim 1, further comprising:
providing the digital pass to one or more electronic devices associated with a same user account.

4. The method of claim 1, wherein transmitting the request to access the service comprises:
presenting an authentication prompt;
receiving an authentication input in response to the authentication prompt;
determining whether the authentication input is valid based on a local authentication data; and
transmitting the request to access the service in response to a determination that the authentication input is valid.

5. The method of claim 1, wherein the digital signature is generated with a private key associated with the digital pass such that the digital signature can be verified by a public key associated with the digital pass.

6. The method of claim 1, wherein receiving the digital pass from the first server comprises provisioning, on a secure element of a user device, the digital pass.

7. The method of claim 1, wherein transmitting at least the portion of the digital pass comprises receiving a selection of at least one attribute from the one or more attributes from a user.

8. The method of claim 1, further comprising:
receiving, from the first server, an indication of a modification of the one or more attributes; and
modifying the one or more attributes based on the indication of the modification.

9. A system comprising:
a memory; and
a processor circuit configured to:
receive a digital pass from a first server, wherein the digital pass comprises one or more attributes;
transmit, to a second server, a request to access a service associated with at least one of the one or more attributes of the digital pass;
receive, from the second server, a request for verification of the one or more attributes;
transmit, responsive to the request, at least a portion of the digital pass to the second server for verification of the one or more attributes, wherein the at least a portion of the digital pass includes a digital signature associated with the digital pass; and
access the service via the second server based at least in part on transmitting the at least the portion of the digital pass to the second server.

10. The system of claim 9, wherein the processor circuit is further configured to:
transmit, to a third server, a request to access another service associated with at least one of the one or more attributes;
receive, from the third server, a request for verification of the one or more attributes;
transmit, responsive to the request, at least a portion of the digital pass to the third server for verification of the one or more attributes, wherein the at least a portion of the digital pass includes the digital signature associated with the digital pass; and
access the other service via the third server based at least in part on transmitting the at least the portion of the digital pass to the third server.

11. The system of claim 9, wherein the processor circuit is further configured to:
provide the digital pass to one or more electronic devices associated with a same user account.

12. The system of claim 9, wherein transmitting the request to access the service comprises:
presenting an authentication prompt;
receiving an authentication input in response to the authentication prompt;
determining whether the authentication input is valid based on a local authentication data; and
transmitting the request to access the service in response to a determination that the authentication input is valid.

13. (canceled)

14. (canceled)

15. (canceled)

16. (canceled)

17. (canceled)

18. (canceled)

19. (canceled)

20. (canceled)

21. A non-transitory computer-readable medium storing instructions that, when executed by a processor, causes the processor to perform operations comprising:
receiving a digital pass from a first server, wherein the digital pass comprises one or more attributes;
transmitting, to a second server, a request to access a service associated with at least one of the one or more attributes of the digital pass;
receiving, from the second server, a request for verification of the one or more attributes;
transmitting, responsive to the request, at least a portion of the digital pass to the second server for verification of the one or more attributes, wherein the at least a portion of the digital pass includes a digital signature associated with the digital pass; and
accessing the service via the second server based at least in part on transmitting the at least the portion of the digital pass to the second server.

22. The non-transitory computer-readable medium of claim 21 storing instructions that causes the processor to perform operations further comprising:
transmitting, to a third server, a request to access another service associated with at least one of the one or more attributes;
receiving, from the third server, a request for verification of the one or more attributes;
transmitting, responsive to the request, at least a portion of the digital pass to the third server for verification of the one or more attributes, wherein the at least a portion of the digital pass includes the digital signature associated with the digital pass; and
accessing the other service via the third server based at least in part on transmitting the at least the portion of the digital pass to the third server.

23. The non-transitory computer-readable medium of claim 21 storing instructions that causes the processor to perform operations further comprising:
providing the digital pass to one or more electronic devices associated with a same user account.

24. The non-transitory computer-readable medium of claim 21, wherein transmitting the request to access the service comprises:
presenting an authentication prompt;
receiving an authentication input in response to the authentication prompt;
determining whether the authentication input is valid based on a local authentication data; and
transmitting the request to access the service in response to a determination that the authentication input is valid.

25. The non-transitory computer-readable medium of claim 21, wherein the digital signature is generated with a private key associated with the digital pass such that the digital signature can be verified by a public key associated with the digital pass.

26. The non-transitory computer-readable medium of claim 21, wherein receiving the digital pass from the first server comprises provisioning, on a secure element of a user device, the digital pass.

27. The non-transitory computer-readable medium of claim 21, wherein transmitting at least the portion of the digital pass comprises receiving a selection of at least one attribute from the one or more attributes from a user.

28. The non-transitory computer-readable medium of claim 21 storing instructions that causes the processor to perform operations further comprising:
receiving, from the first server, an indication of a modification of the one or more attributes; and
modifying the one or more attributes based on the indication of the modification.
